(19) United States
(12) Patent Application Publication
(10) Pub. No.: US 2026/0057458 A1
(43) Pub. Date: Feb. 26, 2026

(54) INTELLIGENT BUSINESS DRIVEN ENERGY MANAGEMENT SYSTEM

(71) Applicant: BUDDERFLY, INC., Shelton, CT (US)

(72) Inventors: Al Subbloie, Orange, CT (US); Christopher J. DeBenedicitis, Branford, CT (US); Ibhade Eigbobo, Aventura, FL (US); Kenneth Buda, Aventura, FL (US); Jaan Leemet, Aventura, FL (US)

(73) Assignee: BUDDERFLY, INC., Shelton, CT (US)

(21) Appl. No.: 19/196,482

(22) Filed: May 1, 2025

Related U.S. Application Data
(60) Provisional application No. 63/685,770, filed on Aug. 22, 2024.

(51) Int. Cl. G06Q 50/06; G06Q 50/12

(52) U.S. Cl. CPC G06Q 50/06; G06Q 50/12

(57) ABSTRACT

A system and method of energy resource reservation for an energy storage system based on business requirements is presented. Energy reservations are created and prioritized based on both energy savings potential and business continuity needs.

### FIELD OF THE INVENTION

The present invention relates to systems and methods of stored energy management, more particularly for management of stored energy and its consumption based on predictive needs in comparison to the criticality (or not) of those needs.

### BACKGROUND OF THE INVENTION

There are many ongoing initiatives to deploy and utilize renewable energy sources. Such systems typically use an energy storage device, such as a high-capacity battery, which can be charged and later utilized to provide power at strategic times. The optimal charging and discharging times are usually based on a variety of factors with an end goal of storing the maximum amount of energy to be used for reducing energy costs. Addressing peak energy demand and reducing overall energy consumption when energy costs are highest are the traditional methods of lowering the energy bill.

The charging of the battery is typically performed through renewable sources such as roof top solar, although other sources such as wind turbines, fossil-fuel powered generators, thermal conversion, geothermal, and fuel cells can also be used. Arbitrage opportunities for buying energy from the utility at reduced rates and storing it for later use when rates are higher can also be used where practical.

The move towards renewable energy sources is driven both by a desire to reduce energy costs, and a growing social responsibility and desire to operate with clean energy to limit pollution, offset carbon, slow or reverse global warming, and generally reduce environmental impact.

Consumer perception related to environmentally conciencious business practices is also growing and customers are increasingly sensitive to environmental issues and making ethical choices when it comes to selecting which establishments they frequent and support.

Companies that are leading the way with green initiatives are in a position to benefit substantially.

In some cases, the manufacturers of storage devices, solar panels, fuel cells, and smart panels offer their own energy management systems that leverage their products features and capabilities. These vary in capability greatly, and many have little to no configurable settings that can be tuned to a particular business operation.

Rudimentary systems may simply charge the batteries and then allow the users to decide when to switch to battery mode. Other systems may switch automatically during a detected outage. Some may have knowledge of billing data from the energy utilities, while others may be connected to demand response systems.

One area that is not addressed in these systems is the need for backup energy and how to map that to key business functions that may span multiple circuits.

U.S. Pat. No. 10,911,257 to Bedros describes a context-aware smart home energy management system and method. Bedros uses both current and forecasted weather information in determining settings, but Bedros does not discuss the effect of business-related data or how to establish an accurate baseline for estimating or reserving energy for key business processes. Bedros does not address any of the unique requirements present in restaurant operations such as voltage fluctuations or how outages may affect business continuity.

U.S. Pat. No. 11,416,017 to Nesler, relates generally to the field of building management systems. The present invention more particularly relates to systems and methods for integrating a building management system with smart grid components and data. A smart meter configured to receive time-of-use pricing information is used but Nesler fails to teach any concepts related to external influences or business-related impacts on how to establish an accurate baseline estimation or how to use the energy storage systems for business continuity.

Therefore, a need exists for an energy management system that has business related knowledge about a facility, or like facilities, which can prioritize and manage energy storage to address both business-critical functions as well as energy savings.

### SUMMARY OF THE INVENTION

Accordingly, it is desired to provide a system and method that manages the charging and discharging of energy storage devices tailored specifically to address business needs. In certain aspects, predicted energy needs are prioritized as part of a stored energy reservation system that allocates blocks of energy to fulfill key functions. The availability of charging capacity and cost is factored into the system to achieve a balance between the need to keep energy stores as backup for key business processes and putting the stored energy towards energy savings opportunities. A special emphasis on restaurant operations is depicted in the examples and in the rule set, although this is not intended to be limiting. Optimal energy savings without sacrificing business requirements are achieved using active queue-based management. Energy reservations are reprioritized based on predicted behavior as well as external variables such as weather and business volume. The prediction capabilities improve over time with machine learning (ML) and artificial intelligence (AI) to further optimize energy usage both for energy spend and ensuring uninterrupted operation and consistent quality in the restaurant's operations.

It is an object of the invention to provide a system and method for predicting and mapping energy usage events related to the business including the amount of energy, the timing, and priority of such events as well as which circuits are used. A resource reservation system is provided that allows the system to allocate and reserve stored energy to accommodate these events. The system applies predictive analytics, knowledge of business processes and practices, as well as historical comparisons to determine the energy related variables mapped into the reservation requests.

It is yet another object of the invention to provide a system that leverages data from comparable sites, when available, when mapping out energy reservations and making such estimates. When the system manages multiple sites, for example franchises or businesses similar in nature, it will apply learned behavior from these sites to new installations. Even sites in like locations with similar functions can supply information that can be extrapolated to create the baseline estimates used in setting up the energy reservation system. These parameters can also be setup manually in the system.

It is still another object of the invention to provide a system and method for managing the reservations that allocates and manages the energy storage system to ensure that sufficient charge is available, or will be available, to meet the needs of the reservations. Such a system utilizes outside feeds such as weather, predictive analytics based on historical data, and knowledge of the various charging sources to predict charging availability and cost. The system is capable of managing a variety of energy sources and prioritizing these towards charging energy storage based on cost, availability, reliability, and the urgency to satisfy pending reservations.

It is yet a further object of the invention to provide a system and method of managing the discharging of stored energy to reduce overall energy costs to the facility, while not forsaking the reservations made by business-critical tasks. Such a system factors in energy costs, including variable rate times, demand response windows, and cap tag or peak energy usage periods to optimize savings.

It is yet another object of the invention to provide a system and method that employs additional energy savings methods in a facility by exerting controls over the use, the timing, and the settings of various equipment on the premises. This includes adjusting thermostats, set points, defrost cycles, lighting, variable speed fans, and other such equipment as per both the business needs and the use of sensor data. Such a system provides a traditional energy savings environment where energy use of the equipment is optimized even before the use of reserve energy storage is required. Such a system is also able to exert more stringent controls on energy use of these devices at times when the system is running on reserve power.

These and other objects are achieved by providing a system for controlling energy storage and discharge at a facility. The system includes a computer with software executing thereon, said software configured to control storage and discharge of electrical energy from a storage device associated with the facility. The software is configured to receive usage data indicative of an amount and timeframe for electrical energy usage of a plurality of devices at the facility. The software is further configured to determine an amount of energy generation available at the facility. The software associates a priority level to each of a plurality of components of electrical energy usage indicated by the usage data, wherein the plurality of components of electrical energy usage are each associated with a time frame and with at least one business task such that the priority level is assigned based on how important said at least one business task is. The software further controls storage and discharge of energy associated with said storage device based on the priority level for one or more of the plurality of components of electrical energy usage, the amount of energy generation available and an amount of energy stored in the storage device in order to reserve energy in the storage device for energy usage associated with a relatively higher priority level.

In certain aspects based on determining an insufficient availability of energy from a utility which supplies energy to the facility, said software allows the storage device to supply reserved energy for the relatively higher priority level energy usage. In further aspects the software controls a first set of one or more of the plurality of devices at the facility which are associated with a relatively lower priority level to reduce energy usage by the first set of the one or more of the plurality of devices when it is determined that the availability of energy form the utility is insufficient. In still other aspects the amount of energy generation available is determined at least in part based on weather data and a predicted amount of energy generation at a future time. In yet other aspects, based on the predicted amount of energy generation being sufficient to supply energy for relatively higher priority level energy usage said software allows the storage device to supply reserved energy when a rate for energy usage from a utility is relatively higher. In still other aspects one or more of the at least one business tasks are associated with a restaurant. In other aspects one or more of the at least one business tasks are associated with food preparation in a kitchen. In still other aspects wherein the plurality of components of electrical energy usage are each associated with the group consisting of: an amount of energy usage, a start time for energy usage, a duration for energy usage, an end time for energy usage, at least one of the plurality of devices and combinations thereof. In still other aspects the software controls the storage device to prevent use of the reserved energy for usage for relatively lower priority level components of electrical energy usage unless a lack of generated electricity at the facility or lack of availability of external energy exists such that the reserved energy is made available the relatively higher priority level components of electrical energy usage.

Other objects are achieved by providing a method for controlling energy storage and discharge at a facility comprising one or more of the steps of: receiving usage data indicative of an amount and timeframe for electrical energy usage of a plurality of devices at the facility; determining an amount of energy generation available at the facility; associating a priority level to each of a plurality of components of electrical energy usage associated with a plurality of devices at the facility, each component of electrical energy usage associated with an amount and timeframe for electrical energy usage the plurality of components of electrical energy usage are each associated with a time frame and with at least one business task such that the priority level is assigned based on how important said at least one business task is; and controlling storage and discharge of energy associated with said storage device based on the priority level for one or more of the plurality of components of electrical energy usage, the amount of energy generation available and an amount of energy stored in the storage device in order to reserve energy in the storage device for energy usage associated with a relatively higher priority level to prevent use of the reserved energy for usage for relatively lower priority level components of electrical energy usage unless a lack of generated electricity at the facility or lack of availability of external energy exists such that the reserved energy is made available the relatively higher priority level components of electrical energy usage.

Other objects are achieved by providing a system for controlling energy storage and discharge at a facility. A computer is provided with software executing thereon with the software configured to control storage and discharge of electrical energy from a storage device associated with the facility, wherein the facility includes a kitchen. The software is configured to receive usage data indicative of an amount and timeframe for electrical energy usage of a plurality of devices at the facility, wherein one or more of the plurality of devices are kitchen devices. The software further associates a priority level to each of a plurality of components of electrical energy usage indicated by the usage data, wherein the plurality of components of electrical energy usage are each associated with a time frame and with at least one business task such that the priority level is assigned based on how important said at least one business task is. The software further controls storage and discharge of energy associated with said storage device based on the priority level for one or more of the plurality of components of electrical energy usage, the amount of energy generation available and an amount of energy stored in the storage device in order to reserve energy in the storage device for energy usage associated with a relatively higher priority level to prevent use of the reserved energy for usage for relatively lower priority level components of electrical energy usage unless a lack of generated electricity at the facility or lack of availability of energy external to the facility exists such that the reserved energy is made available the relatively higher priority level components of electrical energy usage. Furthermore, at least one of the higher priority level components of electrical energy usage is associated with the group consisting of: food refrigeration, food freezer, emergency lighting, a point of sale (POS) device and combinations thereof.

Other objects of the invention and its features and advantages and applications will become more apparent from consideration of the following drawings and accompanying detailed description.

### BRIEF DESCRIPTION OF THE DRAWINGS

FIG. 1A is functional flow diagram of the overall system.

FIG. 1B is a functional flow diagram and overview of the various components in the system.

FIG. 2 shows an overview of the various subsystems of FIGS. 1A and B and their interaction.

FIG. 3 Shows the energy reservations subsystem of FIGS. 1A and B.

FIG. 4 Shows the site optimization subsystem of FIGS. 1A and B.

FIG. 5 Shows the energy charging subsystem of FIGS. 1A and B.

FIG. 6 Shows the energy discharging and savings optimization subsystem of FIGS. 1A and B.

FIG. 7 Depicts a simplified illustration of the charging/discharging system of FIGS. 1A and B.

FIG. 8 Shows some sample table entries and a flow of energy levels within the system of FIGS. 1A and B.

### DETAILED DESCRIPTION OF THE DRAWINGS

One area rarely addressed in existing systems is the need for backup energy for key business functions. Using a restaurant environment as an example, we can itemize certain key functions that are mission critical and cannot lose power. These include things like emergency lighting for customer safety, the point of sale (POS) system for sales enablement, refrigeration to preserve inventory and food safety, etc. In some cases, existing systems may seek to use stored energy at a time where purchased energy prices are comparably higher, but if there is a predicted outage or a risk of an outage, that outage could result in food spoilation which is significantly more expensive than paying a higher price for electricity. The present system seeks to solve those issues by predicting business critical needs and storing adequate reserve power based on those predictions.

Many existing systems are also susceptible or vulnerable to voltage fluctuations which may affect food quality and food safety such as electric cooking systems including bread ovens and clamshell type grill tops.

Rather than addressing a particular circuit or device, these business functions may be made up of a combination of processes spanning multiple circuits or plug loads. They may also invoice the use of a particular circuit at a given time. For example, when a restaurant opens in the morning certain key functions have to be accomplished to set the restaurant up for the day's business. These may include a morning bread bake cycle, the starting of various ice and ice-cream makers, and other food preparation activities. This may all occur between 5 am and 6 am daily. Having an energy outage at this time, or voltage fluctuations would affect the whole business operation for the remainder of the day.

Later, when the lunch time rush occurs, the cooking stations, ventilation systems, and food warming stations become instrumental to conducting the day's business. Energy outages or voltage fluctuations at this time would affect lunchtime business and potentially food quality and even food safety.

In each of the two examples above, business volume as well as seasonality also factor into how much energy is needed to complete the tasks at hand. Further, seasonality can affect the timing and priority of tasks and business processes and needs. As business grows, two bread bake cycles may be needed. In the sweltering summer months, additional ice, ice-cream makers, and frosty makers may be needed, whereas in winter months it may take longer to warm up the oven.

While traditional energy management systems direct and reserve power and provide switching to power particular circuits, they do not consider holistic business processes such as these. They also lack knowledge of business practices and processes and how to apply these to the prediction capabilities to extrapolate energy demands. As such, they cannot provide the data needed to implement the reservation system necessary to address the needs of a dynamically changing business environment. Traditional systems are generally more focused on the optimization of energy spend.

Ultimately for a business, while saving energy is beneficial, preserving business capability is as, if not more, important. Key operations, and functions instrumental for keeping the business running must be prioritized over savings for maintaining reserve energy, especially when probabilities of failure, or lack of charge capabilities are predicted.

Excess power, or the expectation that power can be generated and stored in time for when it is needed, can be used to offset energy bills, or sold back to the utility. Where permitted it can be sold to create revenue used to offset energy charges.

An intelligent energy management system is therefore proposed that takes specific business-related requirements into account and prioritizes charging and discharging windows accordingly.

The system dynamically alters the discharge timing of stored energy using prioritized reservations from energy consuming business processes and activities. Rather than focused on devices, such a system benefits by focusing on tasks that must be done prioritized by their business impact.

The system also allocates supplemental or excess energy towards energy saving initiatives but keep the needs of the business ahead of these. The system also assesses the risk for future charging capability as part of the decision-making process when determining the availability of excess energy.

The system also leverages past data from known sites to establish an initial baseline from which to start learning thereby giving it a much more accurate starting point leading to immediate savings and less pendulum like swings as it adjusts its settings to actual data.

In one configuration, an Energy Reservation System is provided that predicts energy usage including the timing, duration, and priority of energy usage events. Events are generated and queued with expected energy usage which are then prioritized by their business impact. Priorities are pre-set as weights that are added to the entries in the reservation queue. Safety items are top priority and include things such as emergency lights and food safety. Business critical functions are next such as the POS system. Third come tasks that are important to business continuity and comfort, etc.

Once the prioritized reservations are created, they are shared with the energy charging system which allocates or reserves energy storage for the necessary tasks at the necessary timing windows. External data about sales volumes, historical energy use, business processes, weather, and billing information are obtained from a central energy management system and aid in setting these variables to the appropriate values. Monitoring and metering energy use further improves these estimates over time.

When the windows arrive, if grid power is available, the system can decide to continue grid power and use the stored energy of the expired reservation for energy savings purposes.

In another configuration, a Site Optimization Subsystem is provided that manages settings, configurations, and availability of certain resources and capabilities within the other subsystems. This subsystem is more like the traditional energy management systems as it utilizes sensors and historical data along with billing data to monitor and manage the day-to-day energy use with or without backup energy storage. Systems such as turning the lights off and lowering the thermostat when no occupancy is detected are the types of features inherent to this subsystem. It can also be directed to go into power savings mode when outages occur and run existing units such as HVAC, refrigeration, lighting among others with maximal energy savings mode to preserve battery power.

It should be noted that while the system description and examples refer to battery, this can take many forms and should not be considered limiting. For example, thermal batteries can be used to offset refrigeration use, compressed air can be pumped under pressure to later be released to generate energy, and various flywheels and springs can be wound up to later be released to provide energy, to just name a few.

In another configuration an Energy Charging Subsystem is provided which manages and predicts charging capacity and cost. For example, it obtains weather data from a central energy management system to predict possible interruptions to solar power, and how this may impact estimates to the resultant battery charge with the assumption that solar power may be limited. Inputs from the energy reservation subsystem in the form of energy request reservations are received and matched up with availability contracts if they can be satisfied. The subsystem then manages the energy storage in a manner that sufficient energy will be available to satisfy these contracts when they come due.

If excess energy is available, or when these contracts expire, the subsystem allocates this additional energy to the energy discharging and savings optimization engine which in turn looks for the most opportune time to utilize the energy maximizing savings. It should be noted that the subsystem may utilize grid energy to charge the batteries when it is in need of energy to satisfy pending energy reservation contracts. When solar is available, it is deemed to have zero cost and it will always be used for charging. It will also be directed for consumption if the energy storage subsystem is full or sold back to the utility if generation exceeds consumption and storage is full.

In another configuration an Energy Discharging and Savings Optimization Subsystem is provided. This subsystem manages the discharging of the energy storage should an outage be detected or should there be excess energy beyond the reserved energy requirement.

This subsystem can also interface with more specialized systems to profit from the excess energy available by interfacing with external systems that specialize in arbitration and bidding on open energy markets. Further, some components such as smart panels provide local energy management algorithms and capabilities which can also be leveraged by the subsystem through interfacing directly with these subsystems.

During energy outages, the subsystem will communicate with the site optimization subsystem to minimize energy consumption by devices on the site. The subsystem also receives data about tariffs and energy costs from the central energy management system and uses this to determine the most opportune time to use available excess power. For example, if peak usage periods, Demand Response windows or high energy rate windows are imminent, the subsystem will store the excess available energy to use where it will save the most money. It is assumed that business critical functions have placed energy reservations and any energy storage beyond this amount can be used to reduce the energy bill.

In reviewing a use case from a restaurant environment, let us consider the following example. A sit-down dining establishment has high billing charges at dinnertime when a substantial amount of energy is required for cooking and heating (or cooling). The situation is further exasperated by a tiered cost basis whereby energy rates are higher in this demand window. Add to that, the energy demands are increased with the frequent door opening and a full dining room while every burner is operating in the kitchen to accommodate the demand.

A well-intentioned conclusion may be that one should utilize all of one's battery power at this time to offset the higher-rate utility charges and lower any possible peak demand.

While this may seem logical, if the reserve energy store is charged using solar panels, depleting the battery at dinner time would forego any reserve power should there be a need for this reserve power before the batteries have time to recharge. This may be late morning at the earliest, provided it is a sunny day. If the likelihood of needing this reserve power is high, perhaps due to impending weather, or simply out of an abundance of caution, one may want to draw power from the grid at lower rates to keep the battery charged, or use grid power after hours to recharge the battery so it's available for the morning.

Knowledge of the restaurant's schedule and business processes reveals a large energy requirement upon opening in the morning that includes bread baking, and food preparation that is required for the expected influx of business during the day. If energy is not available for these times due to an outage, or if power fluctuations or voltage issues are present that may affect food quality, the restaurant may have a problem preparing for the day and may be unprepared and even unable to catch up. Unable to accommodate these tasks in the morning hours could result in a substantial loss of business, reputation, and even the loss of repeat clients.

Further knowledge of the business may also reveal that the morning start-up is generally where many cooking appliances are all turned on at once, and the HVAC is set to cool the facility, icemakers and ice-cream/frosty makers are all set to run as the restaurant prepares for the day. This may in fact be more representative of a peak usage window than the previous evening's dinner rush even if not intuitive from the lack of patrons in the establishment at the time. This may be the time that reserve energy would be most beneficial to offset peak demand resulting in a more dramatic reduction to the overall long term energy costs as compared to the prior evening.

The assumption that one would like to operate using clean, renewable energy to the largest extent possible, can also be factored into the ruleset for using the stored energy. In many cases, the desire to use more clean energy translates to the addition of more energy generation and more energy storage. Limitations would include availability of the capital cost for these energy upgrades, finding suitable areas to deploy them, and the rights and permits to install them.

The aspect of clean energy also factors into the choice between the sources used for charging and for powering the facility. The grid or the utility is the traditional energy source, and while the utilities have massive economies of scale for energy creation, they suffer from equally massive losses in efficiency due to transmission costs of transporting the energy from distant plants to the facility. This may make them less competitive with local energy supplies such as community solar. Even within the utility, the nature of the energy supply varies. Some utilities using hydroelectric generation may be considered green, whereas coal burning, or other fossil fuel-based utilities would be at the other end of the spectrum ranging from relatively clean natural gas to coal or wood burning systems.

Ongoing initiatives to regulate and mandate the use of green or renewable energy further drive these initiatives. As far back as 2005, the Energy Policy Act mandated that the Federal Government must consume at least 7.5 percent of its energy from renewable sources. Many countries have renewable energy policy targets along the same lines driving a further push towards the use of renewable energy.

While examples depicted in the disclosure relate to a single facility with its own renewable energy source and storage system, it is envisioned that the concepts presented in terms of an energy reservation system and contractual guarantees of energy could also be extended across multiple sites and to a community level. In broad strokes, during times of heavy energy needs priorities could be based on a communal good such as hospitals and fire departments having priority energy contracts over others.

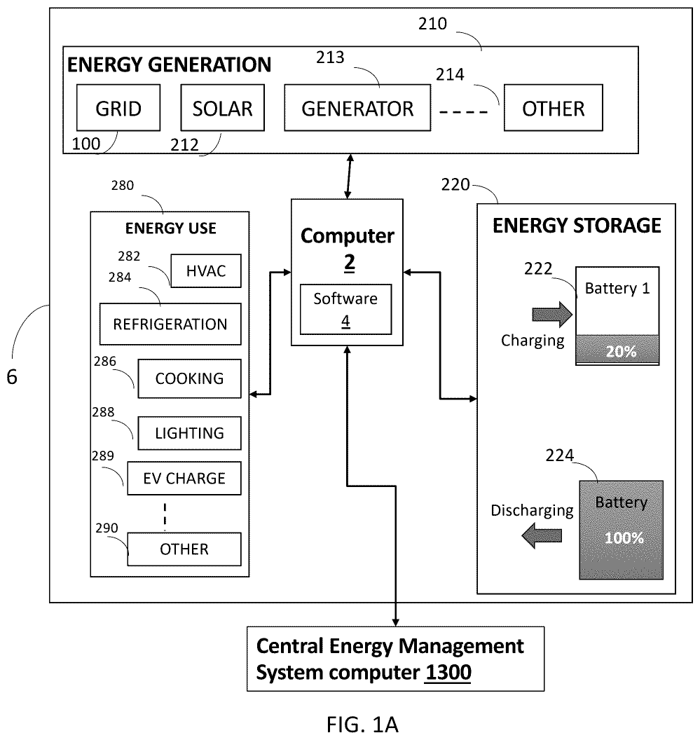

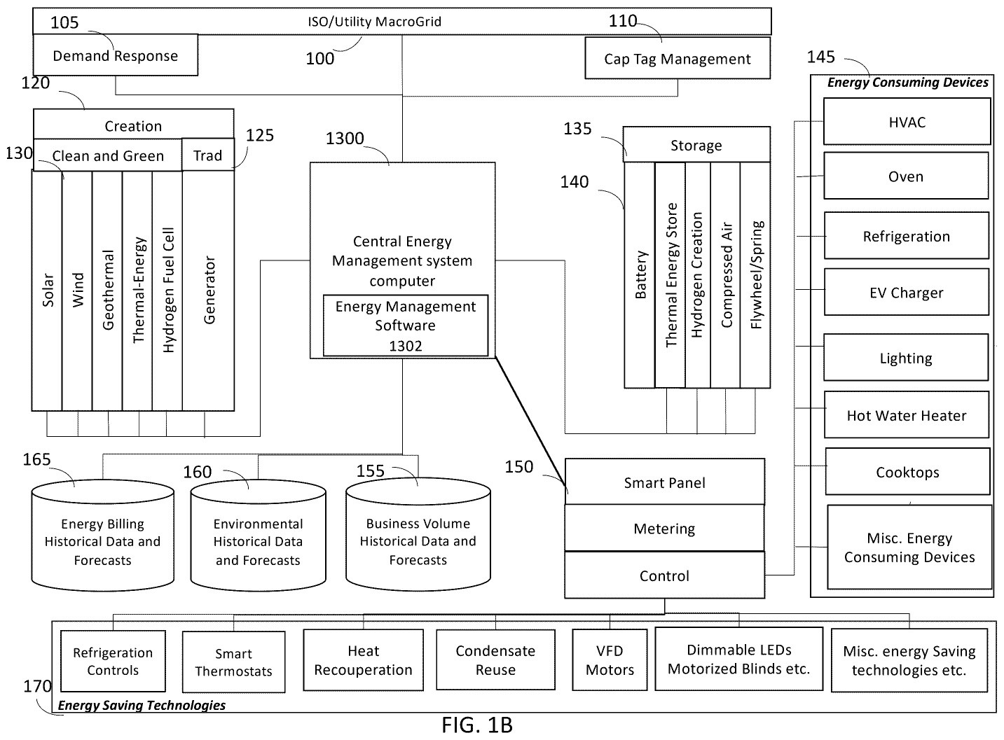

Referring now to the drawings, FIG. 1A is an overview of the facility 6 and the various components therein including the computer 2 and software 4 which controls operation of the storage 220 and use 280 and generation 210 features. The computer 2 may be controlled or instructed by the central management computer 1300. In certain aspects, the computer 2 may not be used and instead the management software 4 shown in FIG. 1A may be incorporated into and execute on the central computer 1300. FIG. 1B provides further details on the components of FIG. 1A and provides an overview of the various components in a typical energy management system. The Utility Grid 100 is the primary source of energy for most facilities and benefits from economies of scale but must endure the losses of transporting the energy over lines to the facility. That said, over the years this has become a reliable source that most everyone relies on The Utility Macrogrid 100 also provides features such as demand response 105. This is a way for facilities to subscribe to agreement-based reductions in energy consumption when the utility needs these. There are windows with varied timing for this, but in essence the sooner a system is able to provide power reduction (on short notice) the better the rate of savings that can be obtained.

Further, the utility performs cap tag management 110 which is a way to analyze and measure peak usage from a given facility.

The cap tags are used to set and allocate subscribers into demand-based categories and set the demand charges on one's bill for as long as 3-12 months. In essence, the utility will maintain sufficient power to provide this cap tag-based amount to a given facility when it is needed. Reductions to peak demand can be quite lucrative for a facility as lowering peak demand can also lower energy costs for months at a time. The demand response 105 and cap tag management 110 systems are preferably controlled by software executing on computers/servers associated with the utility 100.

The central energy management system computer 1300 includes software 1302 which manages and controls the various storage and generation devices based on metered usage and control of various energy consuming devices at one or multiple facilities connected to the utility 100 grid. This central system computer 1300 and software 1302 executing thereon communicates with the various devices shown in FIG. 1. Some example energy creation/generation 120 services/devices which are further categorized into a clean 130 group and a traditional 125 group. These sources can all generate energy which can be used by the facility and the use of this energy is governed by the intelligent energy manager 1300.

Also depicted are various energy storage 135 devices and systems such as batteries 140 and others.

A smart panel 150 is used that performs metering and control of the energy consuming devices 145 at the facility. These include HVACs, ovens, lighting, refrigeration and more.

The Smart panel 150 also controls a number of energy savings technologies 170 that can contribute to the energy savings capabilities of the system. These include systems such as refrigeration controls, smart thermostats, Heat recuperations, condensate reuse, variable speed motors and the like.

Data that is input to the decision-making processes of the central energy management system 1300 includes energy billing data and forecasts 165, environmental data both historical and forecasts 160 and business volume data, again both historical and forecasts.

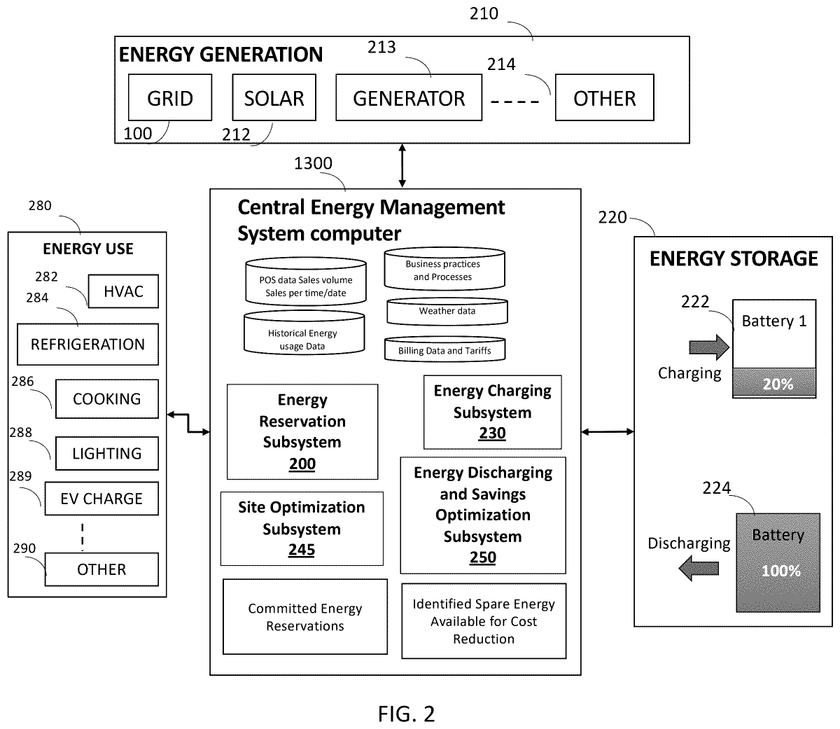

Turning now to FIG. 2, we see an overview of the various subsystems in the intelligent business driven energy management system.

An energy reservation system creates reservations for energy needs based on input from the central energy management system that includes data from the businesses POS system, historical energy usage data, business practices, weather data, and billing data and tariffs. Patterns of energy usage are created based on historical data on energy use. The reservation records include circuit descriptions along with the amount of energy needed, the start time and duration. These records are not for particular circuits but rather for business events. For example, a morning startup sequence may involve baking bread, starting a coffee maker, along with the icemaker. These events are logged in a single record with a start time and a duration. The sequence of business logic and rules can be manually entered by the business owner or restaurant manager, or it can be downloaded from the central energy management system based where it is created based on historical data, and the knowledge of other like sites.

Energy reservation events 240 are provided to the energy charging subsystem 230 that manages confirming the reservations based on current charge in the energy storage system 220 and the predicted charge. Predicted charges are also based on inputs from the central management system where weather data, grid quality, and historical outage data or outage notifications are used. The energy charging subsystem can select between various energy generation 210 devices such as the grid 100 solar 212 a local generator 213 or other sources 214. The choice of using renewable energy such as solar, which is essentially free, is always the default selection when available. The system can also generate energy from multiple sources if the demands of the reservation system exceed the charge rate of solar. Costly charging systems such as starting the local generator or using energy from the grid can be used if the system predicts that it cannot meet the demands of the reservations on hand. Arbitrage opportunities where data from the savings optimization subsystem 250 or central management system determines it can buy low-cost energy and off set high-cost usage windows or offset peak demand may also trigger using grid power. Again, the discharging of energy from the storage system is only done with the excess energy beyond the reserved energy amounts except in special cases.

The energy storage 220 can encompass multiple batteries 222 and 224 in the figure, which can be simultaneously charging and discharging. It should again be noted that while batteries are used in the examples, alternate energy storage systems could also be used in the same way.

If the energy discharging and savings optimization subsystem 250 determines that spare energy 260 is available, it communicates with the site optimization subsystem 245 to discharge and offset energy use. The site optimization subsystem 245 can direct this energy to the appropriate energy usage devices 280 be that the HVAC 282 refrigeration 284 cooking 286 lighting 288 EV charging 289 or other devices 290 on site.

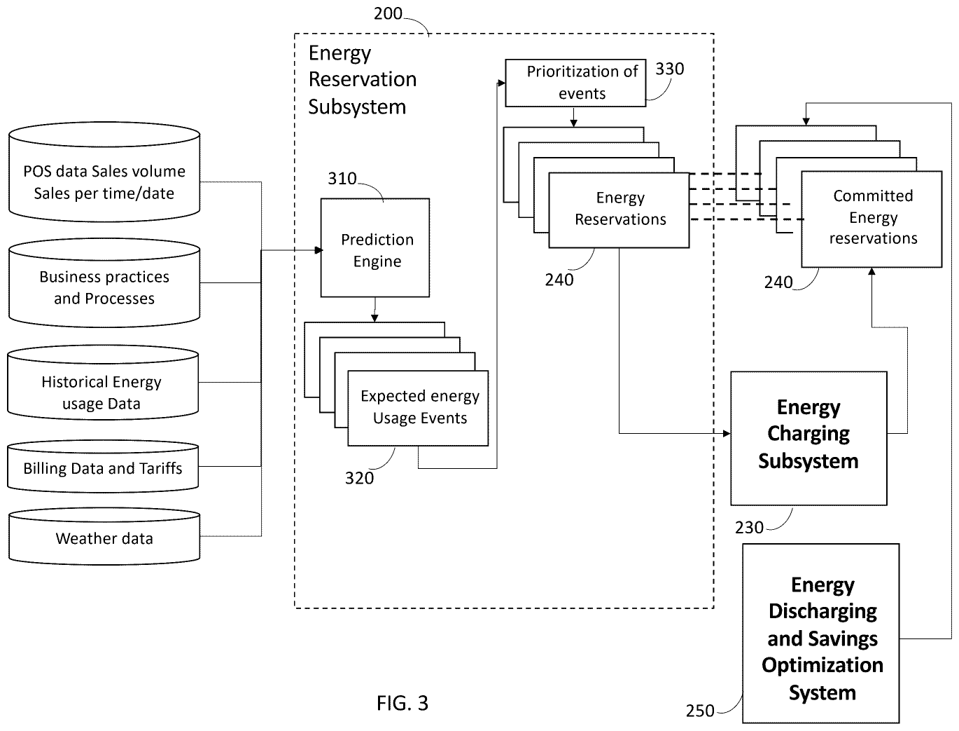

Turning now to FIG. 3. We will see the energy reservation system in more detail. The energy reservation subsystem 200 is made up of a prediction engine 310 that creates the energy usage events. This system applied machine learning and artificial intelligence to determining priorities and timing. This is done with the assistance of input from the central energy management system including data from the businesses POS system, historical energy usage data, business practices, weather data, and billing data and tariffs. Patterns of energy usage are created based on historical data on energy use. Most restaurants have distinct business processes that are repeated at regular intervals, usually daily. Energy is reserved and prioritized for these events by the system to ensure that even during an outage, the energy storage system will safeguard the required amounts for the processes at hand.

The reservation records include circuit descriptions along with the amount of energy needed, the start time and duration. Additionally, the records are prioritized based on a weighted system whereby security related events such as emergency lighting are classifies as top priority, both food safety and employee safety events are in this classification as are business safety systems such as the property alarm.

Business critical processes such as the running of the point-of-sale systems are also created. In these continual type processes the event duration is set to unlimited to ensure continual uptime.

Again, these records are not for particular circuits but rather for business events. Business related processes and sequences are mapped. For example, when shutting down there may be a sequence that involves running the dishwasher, various cleaning processes and finally turning on the alarm and locking the windows and doors.

The expected energy events 320 are queued and prioritized 330 and the amount of energy necessary is estimated and reflected in a subsequent energy reservation 240. These are shared with the energy charging subsystem 230 that creates matching committed energy availability reservations 240 or committed contracts assuming sufficient charge is available. Excess energy and expired contracts from the above are managed by the energy discharging and savings optimization subsystem.

For example, much of the reservation process is done for a case when an outage may occur. If no outage occurs, the system may still opt to use the reserve energy or the energy discharging and savings optimization system may decide instead to keep this energy in reserve and satisfy the contract with energy from the grid.

Again, the system is aided by the central management system 300 that provides data from various external and internal systems as previously described.

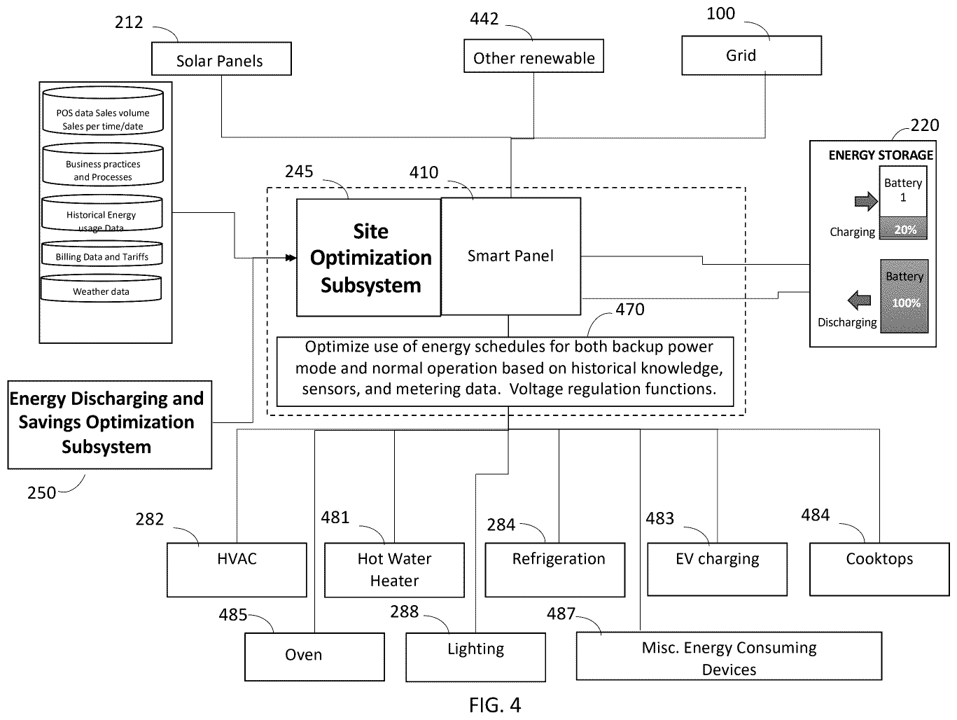

Turning now to FIG. 4 we see the site optimization subsystem. This system is akin to many of the existing energy management systems in that the system will try to optimize energy use across various devices such as HVAC 282 hot water heaters 481 refrigeration 284 EV charging 483 cooktops 484 ovens 485 lighting 288 and miscellaneous energy consuming devices 487. This optimization includes using sensors for occupancy, for example to adjust setpoints on the thermostat on HVAC, adjusting the timing of defrost cycles on refrigeration so they do not occur during peak usage periods, etc. Additionally, when integrated with the intelligent business driven energy manager's other subsystems this subsystem will provide additional functionality.

In cases of power outage, signals from the energy discharging and savings optimization subsystem 250 may direct the system into low-power mode whereby, similar to peak demand windows, the system will do all it can to limit power use. This is to satisfy the Savings Optimization system 250 from having to run expensive generators or other such devices to provide power above what is stored in the energy store.

Additionally, data from the central management system 1300 such as sales data and business process data and billing and weather data can help the system prepare for storms and work schedules by preheating or precooling spaces, among other things.

The renewable sources such as solar 212 and other 214 are connected to a smart panel 410 that works in conjunction with the site optimization subsystem 245, The battery system 220 as well as the grid 100 is also connected and while the various subsystems 250 245 230 aid in decision making as to where and when to draw power, the smart panel 410 has the physical connections to the power sources, and the switching logic to direct the power as needed to satisfy the reservations.

This system also employs site specific energy savings devices such as reusing exhaust heat to offset or eliminate traditional heating elements, reusing water to make compressors more efficient, reusing the cold-water runoff from icemakers, using variable speed fans, and so on. These all lead to a reduction in energy use at the facility.

In restaurants, even a momentary voltage sag or dip, or worse a longer brown out in voltage and cause a business affecting impact to a restaurant. While at home, we may remark that the usual recipe came out slightly different, when customers go to a restaurant and order their favorite meals, there is an expectation of consistency and quality which, when not adhered to, can cause a loss of business, leave to unfavorable reviews or simply regular repeat customers no longer returning to the establishment.

The energy manager for restaurant specific applications must pay particular attention to these voltage levels and when detecting or anticipating fluctuations. Switching to backup power sources that will provide consistent voltages is key to maintaining consistent quality with the restaurant equipment. In many cases such brown-outs or blips may be present due to weather conditions or simply during high demand periods but additional logic for detection and prediction can be employed.

The system monitors and adjusts supply based on voltage levels. Commercial cooling equipment is not only critical to the operation and business of the establishment. A momentary blip that causes an outage can result in equipment damage, food spoilage, and unhappy customers.

The reboot cycle for some speed ovens can be 20-30 minutes before they are ready to resume normal operations, and these must definitively be avoided. Even worse can be the reset or disruption to a restaurant's POS (point of sale) system or order management systems which are instrumental to the business.

Devices such as thermos-electric conversion devices are employed in the kitchen next to hoods and grills to capture and convert this excess heat to energy before it is expelled in the exhaust vent. A food preparation area, and in particular fast food QSR (Quick Serve Restaurants) often prepare food ahead of time in anticipation of peak restaurant periods. This food is often placed under high-energy heat lamps or other warming trays or systems. The recapture of waste heat and reapplication of this heat for these purposes is also a prime way to save energy overall. The added complexity of managing the flow of waste heat in monitoring and managing these food warming stations is an added complexity for a restaurant specific energy management system.

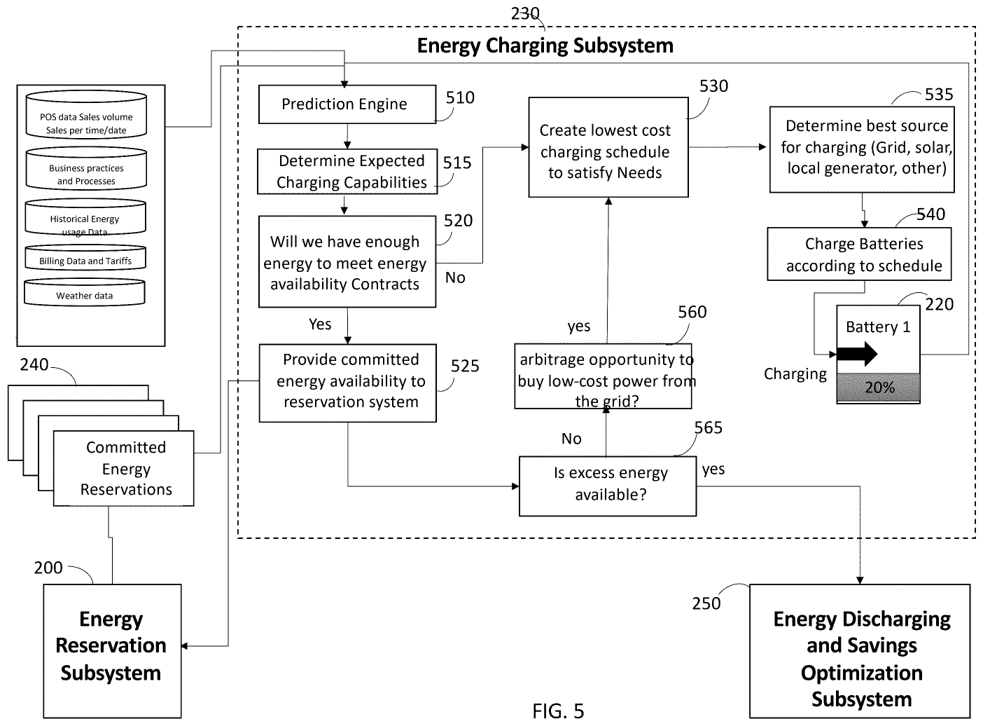

Turning now to FIG. 5, we see the energy charging subsystem 230, a prediction engine 510 makes use of data from the central management system 1300, again made up of POS sales volume data, business process data, historical energy usage, billing and tariff data and weather data. The prediction engine 510 uses the data to predict 515 charge capability and availability in planning to charge the batteries in an energy storage system 220. For example, if using solar, and weather data shows clouds or rain, the system will predict the lack of solar and may retain excess energy in the energy storage system to avoid more costly charging methods to meet the reservation demand. If it is determined that insufficient energy exists to meet the demands 520 then the lowest cost 530 charging methods are selected and 535 charging is done according to schedule 540 to meet the reservation timeline. As an example, if we have provided a reservation contract for 5 pm for 1 hour of energy for a given business process, even if weather is calling for clouds, the system will wait until such time that it needs to generate the charge before resorting to higher cost charging methods. The storm may pass, or other reservations may be cancelled so the added cost may not be necessary. If the system has enough energy to meet availability contracts 520 then it provides the committed energy 525 to the energy reservation system 200 through committed energy reservations 240 or availability contracts.

After ensuring that sufficient energy is available 525 to satisfy the reserved amounts, the system looks at whether excess energy remains 565. If so, it directs the energy savings optimization subsystem 250 to manage the excess energy so as to optimize the savings. This may involve using it immediately or keeping it on hand for a pending peak period, higher rate period, or DR window. If no excess energy is available, the system may attempt to use an arbitrage 560 system to buy lower cost energy from the grid to meet the needs of the reservations.

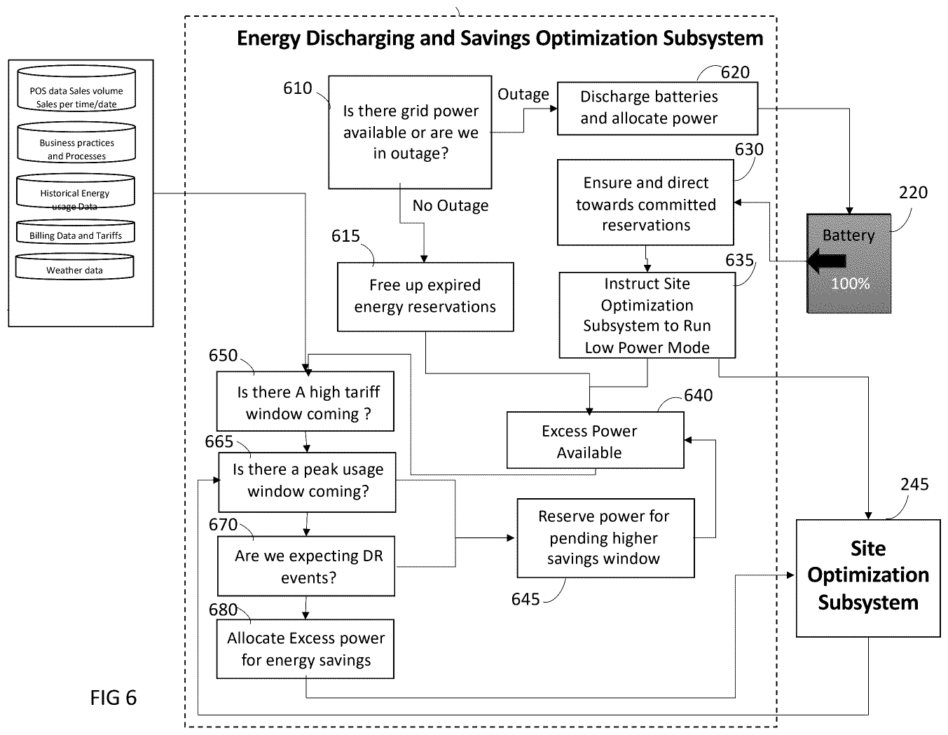

Turning now to FIG. 6 we see the energy discharging and savings optimization subsystem 250. The system monitors for outages 610 and if an outage occurs 620 the batteries in an energy storage system 220 are used to allocate power to the committed reservations 630 made in the system. Further, instructions to run in low-power mode 635 are sent to the site optimization subsystem 245.

If the system is not in outage the system will look to see if any reservations have been satisfied and have expired. 615. For example, if the morning bread-bake cycle is completed, the reservation for energy for the bread oven at 5 am can be removed.

Whether in outage or not, if the system has excess energy 640 that has not been reserved it can use it for energy savings. The energy discharging and Savings optimization subsystem 250 will use data from the central management system 1300 to determine if a higher tariff window is coming 650 if a peak usage window is coming 665 if DR events are expected 670 or if it should allocate excess power to energy savings 680 immediately. This information is provided to the site optimization subsystem 245. It should be noted also that the energy storage subsystem will simultaneously charge and discharge so waiting or saving the charges for later time windows is also calculated with this ongoing charge factor in mind.

Additionally, while the system uses the reservations to manage reserve energy availability, the knowledge of the scheduled pending events also provides insight into possible future peak energy use. Whether or not these events run off battery or from the grid, the system can use the battery to offset these peaks with the knowledge that they are coming. To further illustrate, the Site optimization system is metering energy use and knows of the current energy utilization. It can access the reservation system to see the pending energy usage events and overlay these with the current usage and predicted usage to determine if peak energy usage windows may be triggered.

This information is also provided as part of the decision-making process 665 and also influences both whether or not the system uses the reserve energy from the storage device or the grid when these windows come up, as well as whether or not it uses the excess storage to offset the peaks.

If there is no peak coming up, and the reservation timeline has arrived, the system may decide to continue powering the reservation event with grid power despite having the energy reserved for it. This can be done in cases where a future high-cost event may be pending 650 665 670 and grid power is available, reliable, and we are not in a peak at the present time. The systems logic extrapolate the comparative cost of using the energy now for the reservation .vs. having it available for the pending high cost events assuming insufficient reserve energy exists or will exist at the time of the pending event.

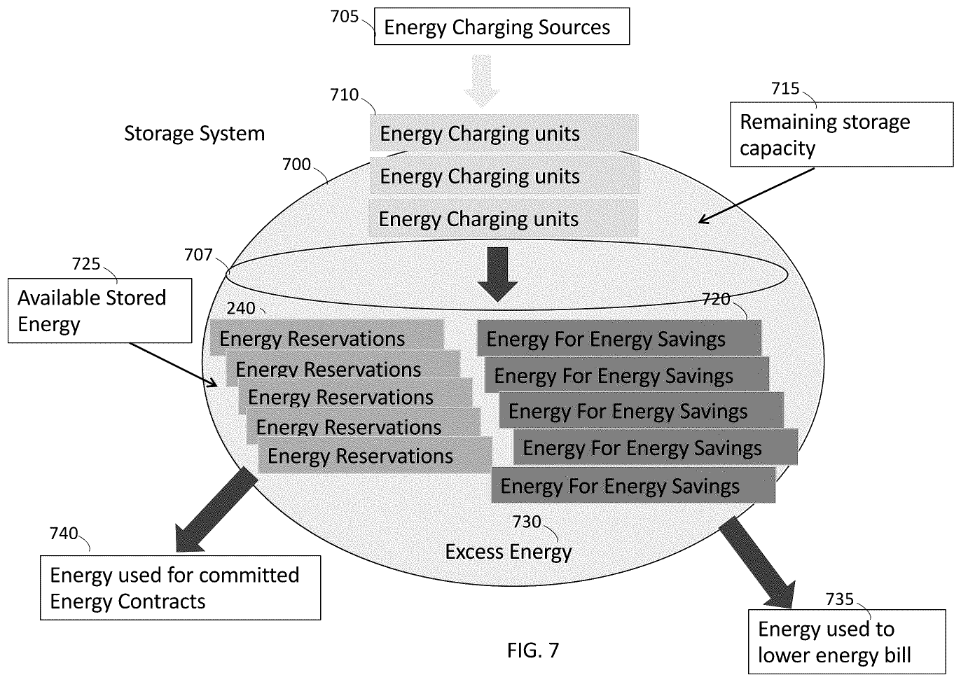

Turning to FIG. 7, we see a fishbowl-like illustration of the energy storage system where the round bowl 700 depicts the overall storage system capacity. A water level marker 707 is shown depicting how available stored energy is below the line at 725 as if the bowl was filled with water and remaining storage capacity 715 is above the line as if air within the fishbowl above the water. Energy charging sources 705 add energy charging units 610 to the storage system 700 thus raising the waterline 707 and adding more stored energy 725. The stored energy 725 is partitioned into energy reservations 710 and energy used for energy savings 720 directed towards use to lower the energy bill 735 with the remaining being excess energy 730. Energy reservations 710 are shown as being used to satisfy committed energy reservations 740 also reducing the water level 707 as available energy 725 is used from the available stored energy.

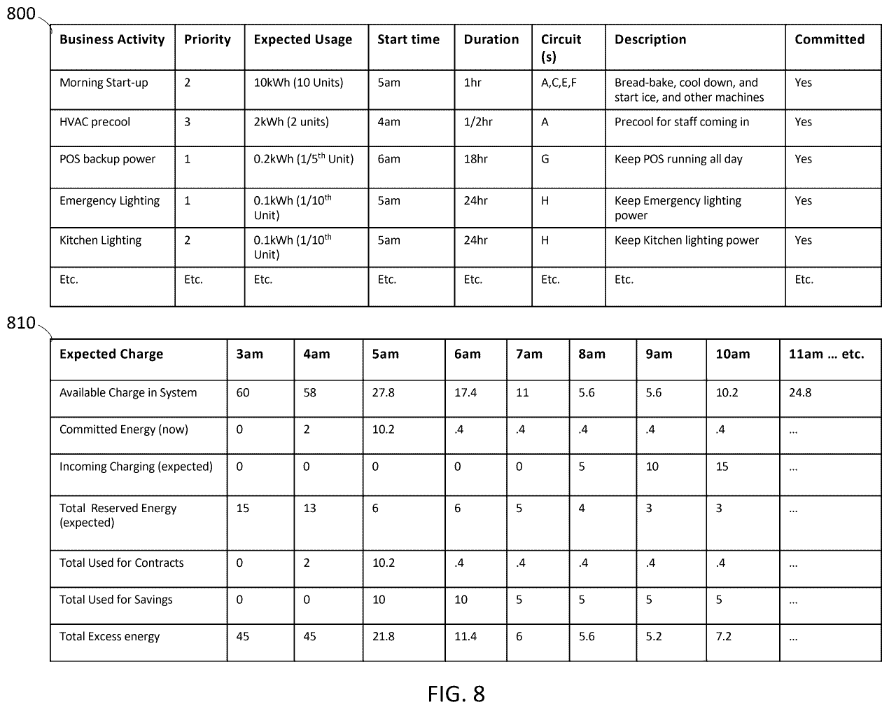

Turning now to FIG. 8 we see a simplified set of tables depicting reservations in the system 800 and energy flow 810 from the various systems. In the first table 800, we see columns depicting the business activities, with priorities, expected energy use, start times, duration, which circuits are used along with a description and whether the energy has been committed by the system. For example, in row 1 we see a morning start-up routine which has a priority of 2 and is expected to use 10 units of power (depicted as 10 kWh in this example). This business process starts at 5 am and lasts for one hour and requires power to circuits A, C, E, and F. It has been committed by the system and the description enters gives more details such as the break-bake and so on.

The second row shows an HVAC pre-cool activity which uses a single circuit A and lasts for ½ hour starting at 4 am. This too has been committed by the system and 2 kWh has been reserved for this priority 3 task.

Additional lines have been added to the table to illustrate a few simple examples of business process events with key variables to depict the system's operation. To simplify the illustration and save space, many variables are not shown such as the probabilities associated with charging, the costs of using the grid power instead of the saved power, etc.

Looking at the second table 810 we see the flow of energy through the system as per the reservations depicted in table 800, each component of the overall energy use as shown may be broken up by circuit or control switch, what the devices are, when the operations occur and how much energy is used and for how long. We start at 3 am with 60 units of energy in the system and no energy has been committed, no charging is expected, and none has been used for contracts or for savings. Of the 60 units of energy, we have reserved 15 units for upcoming events in the reservation system. One will realize that this is slightly more than the addition of the committed events as the system assigns probabilities to the charging to occur later, and if the weather suggests morning clouds, it may take longer to charge the batteries and the savings from using the excess power does not warrant the risk of having to use the grid power to satisfy those contracts should the sun not come out. Again, the example is greatly simplified and used for illustration purposes.

Referring to the second column in table 810 and we see that at 4am we have committed 2 units of power. This is associated with row 2 in table 800, namely the HVAC precool cycle. We'll see now in table 810 we have 58 units of power as the 2 units were used for the committed HVAC pre-cool cycle. We still have 45 units in excess energy available as the 2 units were used and are no longer committed so the reservation is freed up.

Moving on to column 3, or 5 am we now see that there are 10.2 units of energy committed and used. This related to rows 1, 4, and 5 of table 800. Namely the morning startup, the emergency lighting and kitchen lighting using 10, 0.2 and 0.2 units respectively. In this case, we now see that there are only 27.8 units of power available as after using the 10.2 units and another 10 units for energy savings activities this leaves 21.8 units of excess energy. As we move to the 4^{th} column at 6 am, we can see that only 0.4 units of energy are committed matching row 3 of table 800 for the POS backup. The system has used another 5 units of energy for energy savings activities and continues to do so (row 6 in table 810 with columns associated with 7 am, 8 am, 9 am, and 10 am) We also see that starting at 8 am, the solar system used in this example starts providing charge with 5 units (row 3 with column associated to 8 am) and 10 units (row 3 with column associated to 9 am) starting to slowly recharge the batteries and increase the available charge in the system. This simple example is just intended to show how the energy flows through the system in terms of committed reservations and the charging and discharging throughout the day.

Although the invention has been described with reference to a particular arrangement of parts, features and the like, these are not intended to exhaust all possible arrangements or features, and indeed many other modifications and variations will be ascertainable to those of skill in the art.

What is claimed is:

1. A system for controlling energy storage and discharge at a facility comprising:
a computer with software executing thereon, said software configured to control storage and discharge of electrical energy from a storage device associated with the facility;
said software configured to receive usage data indicative of an amount and timeframe for electrical energy usage of a plurality of devices at the facility;
said software further configured to determine an amount of energy generation available at the facility;
said software associating a priority level to each of a plurality of components of electrical energy usage indicated by the usage data, wherein the plurality of components of electrical energy usage are each associated with a time frame and with at least one business task such that the priority level is assigned based on how important said at least one business task is;
said software controlling storage and discharge of energy associated with said storage device based on the priority level for one or more of the plurality of components of electrical energy usage, the amount of energy generation available and an amount of energy stored in the storage device in order to reserve energy in the storage device for energy usage associated with a relatively higher priority level.

2. The system of claim 1 wherein based on determining an insufficient availability of energy from a utility which supplies energy to the facility, said software allows the storage device to supply reserved energy for the relatively higher priority level energy usage.

3. The system of claim 2 wherein said software controls a first set of one or more of the plurality of devices at the facility which are associated with a relatively lower priority level to reduce energy usage by the first set of the one or more of the plurality of devices when it is determined that the availability of energy form the utility is insufficient.

4. The system of claim 1 wherein the amount of energy generation available is determined at least in part based on weather data and a predicted amount of energy generation at a future time.

5. The system of claim 4 wherein based on the predicted amount of energy generation being sufficient to supply energy for relatively higher priority level energy usage said software allows the storage device to supply reserved energy when a rate for energy usage from a utility is relatively higher.

6. The system of claim 1 wherein one or more of the at least one business tasks are associated with a restaurant.

7. The system of claim 6 wherein one or more of the at least one business tasks are associated with food preparation in a kitchen.

8. The system of claim 1 wherein the plurality of components of electrical energy usage are each associated with the group consisting of: an amount of energy usage, a start time for energy usage, a duration for energy usage, an end time for energy usage, at least one of the plurality of devices and combinations thereof.

9. The system of claim 1 wherein the software controls the storage device to prevent use of the reserved energy for usage for relatively lower priority level components of electrical energy usage unless a lack of generated electricity at the facility or lack of availability of external energy exists such that the reserved energy is made available the relatively higher priority level components of electrical energy usage.

10. A method for controlling energy storage and discharge at a facility comprising:
receiving usage data indicative of an amount and timeframe for electrical energy usage of a plurality of devices at the facility;
determining an amount of energy generation available at the facility;
associating a priority level to each of a plurality of components of electrical energy usage associated with a plurality of devices at the facility, each component of electrical energy usage associated with an amount and timeframe for electrical energy usage;
wherein the plurality of components of electrical energy usage are each associated with a time frame and with at least one business task such that the priority level is assigned based on how important said at least one business task is;
controlling storage and discharge of energy associated with said storage device based on the priority level for one or more of the plurality of components of electrical energy usage, the amount of energy generation available and an amount of energy stored in the storage device in order to reserve energy in the storage device for energy usage associated with a relatively higher priority level to prevent use of the reserved energy for usage for relatively lower priority level components of electrical energy usage unless a lack of generated electricity at the facility or lack of availability of external energy exists such that the reserved energy is made available the relatively higher priority level components of electrical energy usage.

11. The method of claim 10 wherein the storage device is located at the facility.

12. The method of claim 10 further comprising controlling storage and discharge of energy associated with said storage device based on a cost of electricity from a utility.

13. The method of claim 10 wherein the usage data includes historical usage data.

14. The method of claim 10 wherein one or more of the at least one business tasks are associated with a restaurant.

15. The method of claim 14 wherein one or more of the at least one business tasks are associated with food preparation in a kitchen.

16. A system for controlling energy storage and discharge at a facility comprising:
a computer with software executing thereon, said software configured to control storage and discharge of electrical energy from a storage device associated with the facility, wherein the facility includes a kitchen;
said software configured to receive usage data indicative of an amount and timeframe for electrical energy usage of a plurality of devices at the facility, wherein one or more of the plurality of devices are kitchen devices;
said software associating a priority level to each of a plurality of components of electrical energy usage indicated by the usage data, wherein the plurality of components of electrical energy usage are each associated with a time frame and with at least one business task such that the priority level is assigned based on how important said at least one business task is;
said software controlling storage and discharge of energy associated with said storage device based on the priority level for one or more of the plurality of components of electrical energy usage, the amount of energy generation available and an amount of energy stored in the storage device in order to reserve energy in the storage device for energy usage associated with a relatively higher priority level to prevent use of the reserved energy for usage for relatively lower priority level components of electrical energy usage unless a lack of generated electricity at the facility or lack of availability of energy external to the facility exists such that the reserved energy is made available the relatively higher priority level components of electrical energy usage;
wherein at least one of the higher priority level components of electrical energy usage is associated with the group consisting of: food refrigeration, food freezer, emergency lighting, a point of sale (POS) device and combinations thereof.

17. The system of claim 16 wherein said software controls a first set of one or more of the plurality of devices at the facility which are associated with a relatively lower priority level to reduce energy usage by the first set of the one or more of the plurality of devices when it is determined that the availability of energy external to the facility is insufficient.

18. The system of claim 16 further comprising said software further configured to determine an amount of energy generation available at the facility and wherein the amount of energy generation available is determined at least in part based on weather data and a predicted amount of energy generation at a future time.

19. The system of claim 18 wherein based on the predicted amount of energy generation being sufficient to supply energy for relatively higher priority level energy usage said software allows the storage device to supply reserved energy when a rate for energy usage from a utility is relatively higher.
